(19) United States
(12) Patent Application Publication
(10) Pub. No.: US 2018/0103417 A1
(43) Pub. Date: Apr. 12, 2018

(54) METHOD AND APPARATUS FOR PERFORMING PROXIMITY SERVICE COMMUNICATIONS IN WIRELESS COMMUNICATION SYSTEM

(71) Applicant: Samsung Electronics Co., Ltd., Suwon-si, Gyeonggi-do (KR)

(72) Inventors: Dae-in CHOI, Hwaseong-si (KR); Jang-gon KIM, Suwon-si (KR); Jae-sung PARK, Yongin-si (KR); Young-kyo BAEK, Seoul (KR); Jae-jun LEE, Suwon-si (KR)

(21) Appl. No.: 15/573,769

(22) PCT Filed: May 18, 2016
(86) PCT No.: PCT/KR2016/005243

§ 371 Date: Nov. 13, 2017

Related U.S. Application Data
(60) Provisional application No. 62/236,440, filed on Oct. 2, 2015.
(60) Provisional application No. 62/163,344, filed on May 18, 2015.

(51) Int. Cl. H04W 48/10; H04W 4/08; H04W 8/00

(52) U.S. Cl. CPC H04W 48/10; H04W 76/02; H04W 88/02; H04W 8/005; H04W 4/08

(57) ABSTRACT

According to an embodiment of the present invention, a method of operating first user equipment (UE) in a wireless communication system includes: determining whether a size of a relay discovery message to be transmitted by the first UE exceeds a permitted size; and broadcasting a plurality of relay discovery messages, based on the relay discovery message and information about a group related to the first UE, when it is determined that the size of the relay discovery message exceeds the permitted size.

### CROSS-REFERENCE TO RELATED APPLICATIONS AND CLAIM OF PRIORITY

This application is a 371 National Stage of International Application No. PCT/KR2016/005243, filed May 18, 2016, which claims the benefit of U.S. Provisional Patent Application No. 62/163,344, filed May 18, 2015 and U.S. Provisional Patent Application No. 62/236,440, filed Oct. 2, 2015, the disclosures of which are fully incorporated herein by reference as if fully set forth herein.

### TECHNICAL FIELD

The present invention relates to a method of performing proximity service communication in a wireless communication system, an apparatus for performing the proximity service communication, and a computer -readable recording medium on which a program for performing the proximity service communications is recorded.

### BACKGROUND

Wireless communication systems are widely deployed to provide communication services of various types such as voice and data. In general, a wireless communication system is a multiple access system capable of supporting communication between multiple users by sharing available system resources (bandwidth, transmission power, etc.). Examples of the multiple access system may include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, a multi-carrier frequency division multiple access (MC-FDMA) system, etc.

Proximity Service (ProSe) is a method of supporting communication between devices located physically in close proximity to each other. In more detail, ProSe may aim to support operations of discovering applications that operate on devices close to each other and of ultimately exchanging application-related data. For example, ProSe may be applied to applications such as social network services (SNSs), businesses, games, or the like.

ProSe may be referred to as Device-to-Device (D2D) communication. In other words, ProSe may denote a communication method by which a direct link is established between a plurality of devices (for example, user equipment (UE)), and user data (for example, voice, multimedia data, etc.) is directly transceived between the devices without passing through a network. ProSe communication may include a method such as UE-to-UE communication and peer-to-peer communication. In addition, a ProSe communication method may be applied to Machine-to-Machine (M2M) communication, machine type communication (MTC), etc. Thus, ProSe may be considered as a solution to solve a burden on a base station due to rapidly increasing data traffic. In addition, by introducing ProSe, effects may be expected such as reduction in procedures of a base station, reduction in power consumption of devices participating in ProSe, an increase in data transmission speed, an increase in network capacity, distributed loads, and an increase in cell coverage.

### SUMMARY

In a wireless communication system according to the present invention, information about a plurality of groups may be transmitted as a plurality of messages and thus, proximity service communication may be efficiently performed.

According to an aspect of the present invention, there is provided a method of operating a first user equipment (UE) in a wireless communication system, the method including: determining whether a size of a relay discovery relay discovery message to be transmitted by the first UE exceeds a permitted size; and broadcasting a plurality of messages, based on the relay discovery relay discovery message and information on a group related to the first UE, when it is determined that the size of the relay discovery relay discovery message exceeds the permitted size.

According to another aspect of the present invention, there is provided a terminal operating in a wireless communication system, the terminal including: a transceiver; and a processor, wherein the processor is configured to determine whether a size of a relay discovery relay discovery message to be transmitted by the terminal exceeds a permitted size, and when it is determined that the relay discovery relay discovery message exceeds the permitted size, broadcasts a plurality of relay discovery relay discovery messages, based on information about a group related to the relay discovery relay discovery message and the terminal.

In a wireless communication system according to the present invention, information about a plurality of groups may be delivered as a plurality of messages so as to efficiently perform proximity service communications.

### BRIEF DESCRIPTION OF THE DRAWINGS

The present invention may be readily understood by combining the following detailed description and accompanying drawings, in which reference numerals refer to structural elements.

FIG. 1A illustrates one-to-one proximity service (ProSe) direct communication according to one embodiment;

FIG. 1B illustrates communication via a ProSe user equipment (UE)-to-network relay, according to one embodiment;

FIG. 2 is a flowchart for describing a method of operating UE performing ProSe communication, according to an embodiment;

FIG. 3 is a flowchart for describing a method of operating UE performing the ProSe communication, according to an embodiment of an operation in FIG. 2;

FIG. 4A shows a table for explaining parameters constituting a relay discovery relay discovery message, according to an embodiment;

FIG. 4B shows a table for explaining the parameters disclosed in FIG. 4A;

FIG. 5A shows a table for explaining parameters constituting a relay discovery relay discovery message, according to another embodiment;

FIG. 5B shows a table for explaining the parameters disclosed in FIG. 5A; and

FIG. 6 is a block diagram illustrating a terminal used in the ProSe communication, according to an embodiment.

### DETAILED DESCRIPTION

According to an aspect of the present invention, there is provided a method of operating a first user equipment (UE) in a wireless communication system, the method including: determining whether a size of a relay discovery relay discovery message to be transmitted by the first UE exceeds a permitted size; and broadcasting a plurality of messages, based on the relay discovery relay discovery message and information on a group related to the first UE, when the size of the relay discovery relay discovery message exceeds the permitted size.

According to another aspect of the present invention, there is provided a terminal operating in a wireless communication system, the terminal including: a transceiver; and a processor, wherein the processor determines whether a size of a relay discovery relay discovery message to be transmitted by the terminal exceeds a permitted size, and when the relay discovery relay discovery message exceeds the permitted size, broadcasts a plurality of relay discovery relay discovery messages, based on information of a group related to the relay discovery relay discovery message and the terminal.

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Throughout the specification, when a portion “includes” an element, another element may be further included, rather than excluding the existence of the other element, unless otherwise described. A term “unit” used in the specification may mean a software or hardware component, such as a field programmable gate array (FPGA) or application specific integrated circuit (ASIC), which performs certain functions. However, a meaning of the “unit” is not limited to software or hardware. The “unit” may be configured to reside on an addressable storage medium and may be configured to execute one or more processors. Accordingly, the “unit” may include, for example, components such as software components, object-oriented software components, class components, and task components, processes, functions, attributes, procedures, subroutines, segments of program codes, drivers, firmware, microcode, circuits, data, databases, data structures, tables, arrays, and variables. Function provided in the components and the “unit”s may be combined into a smaller number of components and “unit”s, or further separated into additional components and “unit”s.

While such terms as “first,” “second,” etc., may be used to describe various components, such components must not be limited to the above terms. The above terms are used only to distinguish one component from another. For example, without departing from the scope of the present invention, a first component may be referred to as a second component, and similarly, the second component may also be referred to as the first component. A term “and/or” may include a combination of a plurality of related listed items or any of a plurality of related listed items.

Embodiments of the present invention may be supported by standard documents published in connection with at least one of the Institute of Electrical and Electronics Engineers (IEEE) 802 systems, 3rd generation partnership project (3GPP) systems, 3GPP long term evolution (LTE) and LTE-advanced (LTE-A) systems, and 3rd generation partnership project 2 (3GPP2) systems. In other words, steps or portions of the embodiments of the present invention that are not described in order to clearly illustrate the technical idea of the present invention may be supported by the documents described above. In addition, all terms disclosed herein may be described by the standard documents described above.

The following techniques may be used in various wireless communication systems. For the sake of clarity, the 3GPP LTE and 3GPP LTE-A systems will be mainly described below, but the technical idea of the present invention is not limited thereto.

Terms used in this document are defined as follows.
User equipment (UE): equipment used by a user. The UE may refer to terms such as a terminal, a mobile equipment (ME), a mobile station (MS), etc. In addition, the UE may be a portable device such as a notebook computer, a mobile phone, a personal digital assistant (PDA), a smart phone, and a multimedia device, or a non-portable device such as a personal computer (PC) or a vehicle-mounted device. The UE may be UE capable of communicating with the 3GPP spectrum and/or WiFi such as LTE and via a non-3GPP spectrum such as public safety spectrum.
Proximity service or proximity-based service (ProSe): services that enables discovery between physically proximate devices, and communication via direct communication/base station communication/a third device. At this time, the user plane data may be exchanged via a direct data path without passing through the 3GPP core network (for example, evolved packet core (EPC)).
Proximity: whether a piece of UE is proximate to another piece of UE is determined by whether a certain proximity criterion is satisfied. The proximity criterion may be differently given for ProSe discovery and ProSe communication. In addition, the proximity criterion may be set so as to be controlled by an operator.
ProSe discovery: denotes a process of using evolved-universal terrestrial radio access (E-UTRA) or identifying which UEs are proximate to other UEs among UEs.
ProSe communication: communication between proximate UEs performed via established communication paths between UEs. The communication path may be directly formed between the UEs or routed through a local base station(s) (evolved node B (eNodeB)).
Packet data network (PDN): denotes a network in which a server supporting a specific service (for example, a multimedia messaging service (MMS) server and a wireless application protocol (WAP) server) is located.
PDN connection: denotes a logical connection between the UE and the PDN, expressed as one internet protocol (IP) address (one IP version 4 (IPv4) address and/or one IP version 6 (IPv6) prefix).
Public land mobile network (PLMN): a network configured to provide mobile communication services to individuals. The PLMN may be separately configured for each operator.
ProSe UE-to-network relay: denotes a ProSe-enabled public safety terminal acting as a communication relay between a ProSe-enabled network using E-UTRA and a ProSe-enabled public safety terminal.
Remote UE: denotes a ProSe-enabled public safety terminal, which is not serviced by E-UTRA network (E-UTRAN) in the UE-to-network network relay operation but is connected to EPC network via the ProSe UE-to-network relay, that is, which is provided with the PDN connection.

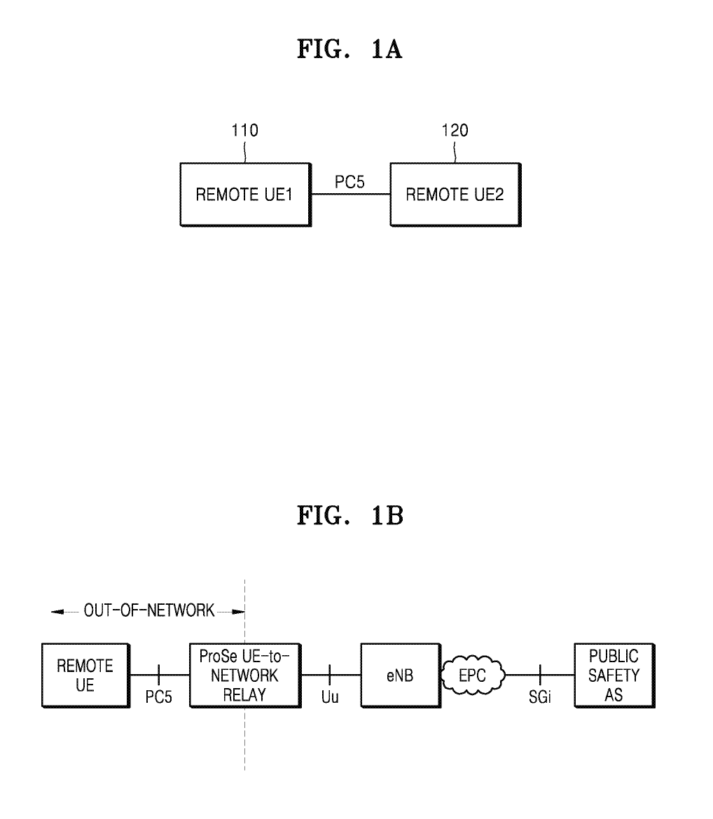

FIG. 1A illustrates one-to-one ProSe direct communication according to an embodiment.

Only the components related to the present embodiment are illustrated in a wireless communication system illustrated in FIG. 1A. Thus, it will be understood by those of ordinary skill in the art that other general-purpose components other than the components illustrated in FIG. 1A may be further included.

Remote UE1 110 and Remote UE2 120 according to an embodiment may perform ProSe one-to-one direct communication. In the ProSe one-to-one direct communication according to an embodiment, each piece of UE may have a layer-2 identifier for direct communication between two pieces of UE via a wireless interface (for example, PC5).

FIG. 1B illustrates communication via a ProSe UE-to-network relay, according to an embodiment.

A purpose of remote UE being connected to the EPC via the UE-to-network relay may be participation in the group communication. For example, UE UE-1 through UE-6 belonging to a same group may receive downlink traffic for a specific media constituting the group communication via unicast or multimedia broadcast multicast services (MBMS). As a result, although the remote UE is not in E UTRA network (E-UTRAN) coverage, the remote UE may transmit media traffic to other group members (that is, generate uplink traffic) or receive media traffic transmitted by other group members, by participating in the group communication via the UE-to-network relay.

A UE-to-network relay discovery may use discovery methods of model a and model b types.

A model a type (“I am here”) discovery may define roles of ProSe-enabled UE as a role of announcing UE and a role of monitoring UE. The announcing UE may be a terminal which announces information that can be used by a terminal in proximity where discovery is permitted, and the monitoring UE may be UE which receives information from the announcing UE. The announcing UE may broadcast a discovery message at certain discovery intervals, and the monitoring UE may read and process the discovery message.

In connection with a UE-to-network relay search operation, when the UE-to-network relay performs the model a type discovery to inform about its existence, information on various parameters may be included in a UE-to-network relay discovery announcement message.

According to the present disclosure, parameters included in the UE-to-network relay discovery announcement message in the model a type discovery may be as follows (hereinafter, descriptions of the same parameters will be omitted). The parameters included in the UE-to-network relay discovery announcement message may include a combination of the following parameters.
Message type: denotes whether a message is an announcement message or a solicitation message/response message.
Discovery type: denotes whether a discovery is UE-to-network relay discovery or group member discovery.
Proximity Service relay UE identifier (ID): denotes a link layer identifier related to a public data network (PDN) and used for the direct communication.
Announcer information: denotes information on the announcing UE. For example, the announcer information may include a session initiation protocol uniform resource identifier (SIP URI), application information, an IP address, and a port number. When a size of the announcer information exceeds a permitted size, the announcer information may be hashed or compressed.
PLMN ID: denotes a public network mobile network identifier.
Connectivity information: denotes a parameter that identifies a connection provided by the ProSe UE-to-network relay.
Status/maintenance flags: denotes whether a relay is temporary or denotes a battery running low indicating that a remote UE is searching for another UE-to-network relay.
Group information: denotes information about a group to which the UE-to-network relay currently relays or information about a group for a remote UE to search for the UE-to-network relay.
Multiple message flag: includes information indicating whether a message is a plurality of messages or one message.
Last message flag: includes information indicating whether a message is a last message.
Radio layer information: includes information indicating a radio status between an evolved node B (eNB) and the UE-to-network relay to help remote UE select an appropriate UE-to-network relay.
Security information

A model b type (“Who is there?”, “Are you there?”) discovery may define, as a role of the UE, a discoverer UE and a discoveree UE. The discoverer UE may request a plurality of pieces of information of interest regarding the discovery, and the discoveree UE may be UE that receives a discovery request and responds with information related to the discovery request. Information about parameters included in a direct discovery message during a UE-to-network relay discovery operation will be described in detail below.

In connection with the UE-to-network relay discovery operation, when the UE-to-network relay performs the model b type discovery, information about various parameters may be included in the UE-to-network relay discovery solicitation message (discovery request message).

According to an embodiment, parameters included in the UE-to-network relay discovery solicitation message in the model b type discovery may be as follows. The parameters included in the UE-to-network relay discovery solicitation message may include a combination of the following parameters.
Message type
Discovery type
ProSe UE ID: denotes a link layer identifier of a discoverer used for the direct communication.
PLMN ID
Connectivity information
Discoverer information: denotes information about a discoverer (for example, an SIP URI, application information, an IP address, and a port number). When the discoverer information exceeds a permitted size, the discoverer information may be hashed or compressed.
Group information
Multiple message flags
Last message flag
Security information

In connection with the UE-to-network relay discovery operation, when the UE-to-network relay performs the model b type discovery, information about various parameters may be included in the UE-to-network relay discovery response message (discovery response message).

According to an embodiment, parameters included in the UE-to-network relay discovery response message in the model b type discovery may be as follows. The parameters included in the UE-to-network relay discovery response message may include a combination of the following parameters.
Message type
Discovery type
ProSe relay UE ID
PLMN ID
Discoveree information: denotes information about a discoveree (for example, an SIP URI, application information, an IP address, and a port number). When the discoveree information exceeds a permitted size, the discoveree information may be hashed or compressed.
Status/maintenance flags
Group information
Multiple message flags
Last message flag
Radio layer information
Security information

In addition, group member discovery may use the discovery methods of model a and model b types.

According to an embodiment, parameters included in the group member discovery announcement message in the model a type discovery may be as follows. The parameters included in the group member discovery announcement message may include a combination of the following parameters.
Message type
Discovery type
ProSe UE ID: denotes a link layer identifier used for the direct communication.
Announcer information: denotes information about the announcing UE. For example, the announcer information may include an SIP URI, application information, an IP address, and a port number. When the announcer information exceeds a permitted size, the announcer information may be hashed or compressed.
Layer 2 group ID: denotes a link layer identifier used for the group communication.
Security information

According to an embodiment, parameters included in the group member discovery solicitation message in the model b type discovery may be as follows. The parameters included in the group member discovery solicitation message may include a combination of the following parameters.
Message type
Discovery type
ProSe relay UE ID
Discoverer information
Target information: includes information about a targeted discoveree. The target information may include information about the UE ID or the layer 2 group ID.
Layer 2 group ID
Security information

According to an embodiment, parameters included in the group member discovery response message in the model b type discovery may be as follows. The parameters included in the group member discovery response message may include a combination of the following parameters.
Message type
Discovery type
ProSe relay UE ID
Discoveree information
Layer 2 group ID
Security information

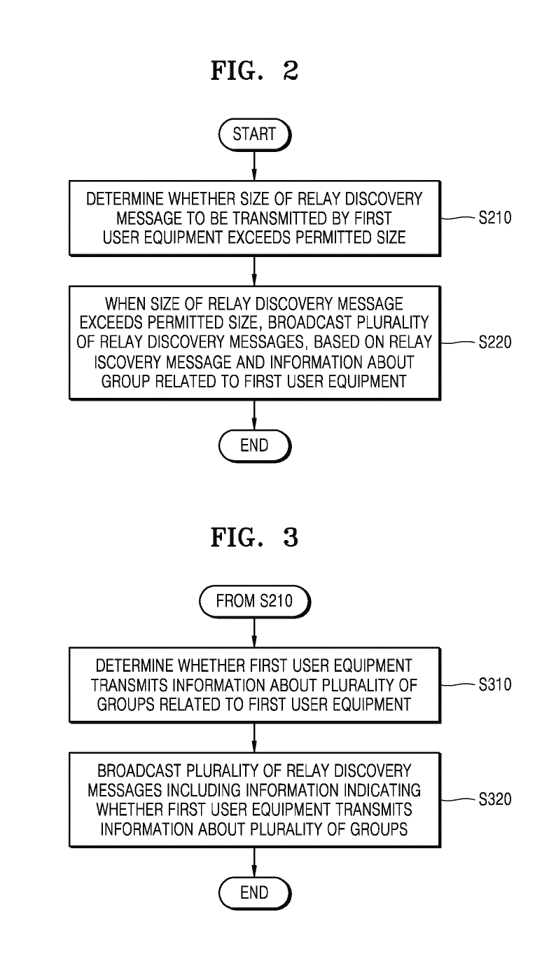

FIG. 2 is a flowchart illustrating a method of operating a first UE for performing the ProSe communication according to an embodiment.

In step S210, the first UE may determine whether a size of a relay discovery message to be transmitted thereby exceeds a permitted size.

In step S220, when the size of the relay discovery message exceeds the permitted size, the first UE may broadcast a plurality of relay discovery messages, based on the relay discovery message and information on a group related to the first UE.

Here, the relay discovery message may include the UE-to-network relay discovery announcement message, the UE-to-network relay discovery solicitation message, the UE-to-network relay discovery response message, the group member discovery announcement message, the group member discovery solicitation message, the group member discovery response message, the relay discovery response message, a relay discovery Additional information message, a temporary mobile group identify (TMGI) monitoring request message, and a TMGI monitoring response message, but the present invention is not limited thereto.

In addition, the first UE may establish a connection for the direct communication with a second UE determined as the UE-to-network relay.

FIG. 3 is a flowchart describing a method of operating the first UE performing the ProSe communication, that is, the step S220 in FIG. 2 according to an embodiment.

In step S310, the first UE may determine whether to transmit information on a plurality of groups related to the first UE. For example, the plurality of groups related to the first UE may be a first group, a second group, and a third group. The first UE may determine whether to transmit information on the first group, the second group, and the third group to the second UE proximate to the first UE.

In step S320, the first UE may broadcast a plurality of relay discovery messages including information indicating whether to transmit information on the plurality of groups. For example, the multiple message flag may denote whether to transmit information on the plurality of groups. When a value of the multiple message flag is about 1, the first UE may broadcast a plurality of relay discovery messages. On the other hand, when the value of the multiple message flag is about 0, the first UE may broadcast one relay discovery message.

The first UE may broadcast a first relay discovery message including information on the first group of the plurality of groups, and broadcast a second relay discovery message including information on the second group of the plurality of groups.

In addition, each of the plurality of relay discovery messages may include information indicating whether each of the relay discovery messages is a last message transmitted by the first UE. For example, a last message flag may denote that the relay discovery message is the last message transmitted by the first UE. When a value of the last message flag included in the relay discovery message is about 0, the relay discovery message may not be the last message. On the other hand, when the value of the last message flag included in the relay discovery message is about 1, the relay discovery message may be the last message.

In addition, the relay discovery message may include a link layer identifier of a group used for the group communication. The link layer identifier may be differently set for each group and used for group identification.

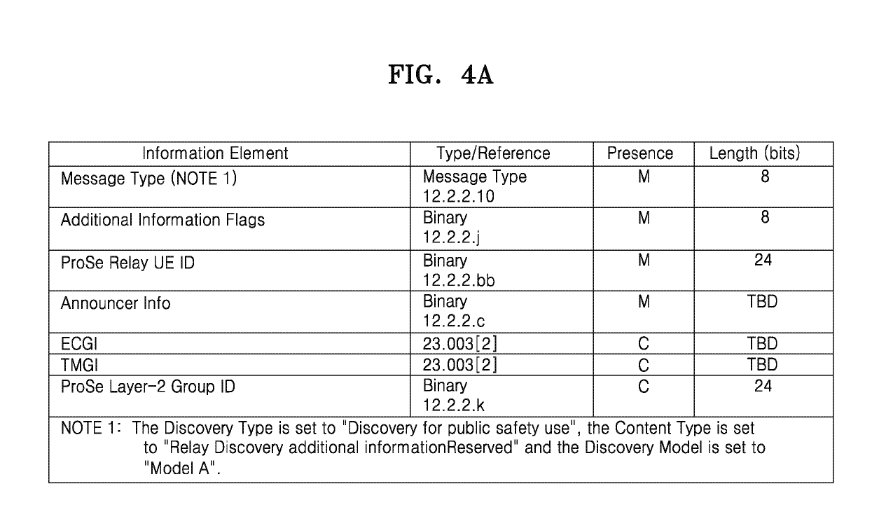

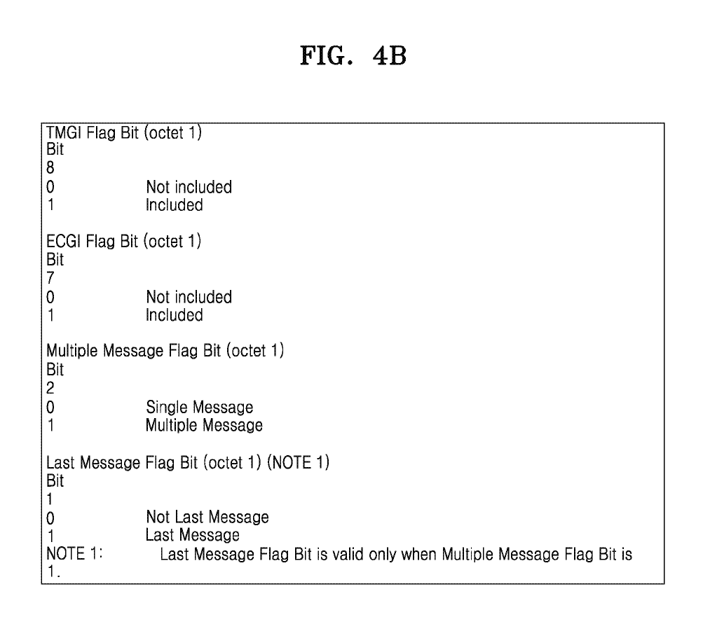

FIG. 4A shows a table for explaining parameters constituting the relay discovery message according to an embodiment.

As illustrated in FIG. 4A, the relay discovery message may include the message type, a supplementary information flag, the ProSe relay UE ID, the announcer information, E-UTRAN cell global identification (ECGI), TMGI, parameters for the ProSe layer 2 group ID, and information on parameters. It will be understood by those skilled in the art that the relay discovery message may further include parameters other than the parameters illustrated in FIG. 4A.

FIG. 4B shows a table for explaining the parameters disclosed in FIG. 4A.

Referring to FIG. 4B, when a bit of an ECGI flag is about 0, ECGI may not be included in the relay discovery message. When the bit of the ECGI flag is about 1, ECGI may be included in the relay discovery message and a value of ECGI may be obtained therefrom.

When a value of TMGI is about 0, TMGI and the ProSe layer 2 group ID may not be included in the relay discovery message. When the value of TMGI is about 1, TMGI and the ProSe layer 2 group ID may be valid and values of parameters may be obtained from the relay discovery message.

In addition, when the size of the relay discovery message is larger than a permitted size of a message, the multiple message flag may be set to about 1 and information on the message may be transmitted via the multiple message.

When the multiple message flag is about 0, the message may be a single message and the last message flag may be invalid. On the other hand, when the multiple message flag is about 1, the message may be at least one message and the last message flag may be valid. In addition, when the last message flag is about 0, the message may not be the last message. When the last message flag is about 1, the message may be the last message.

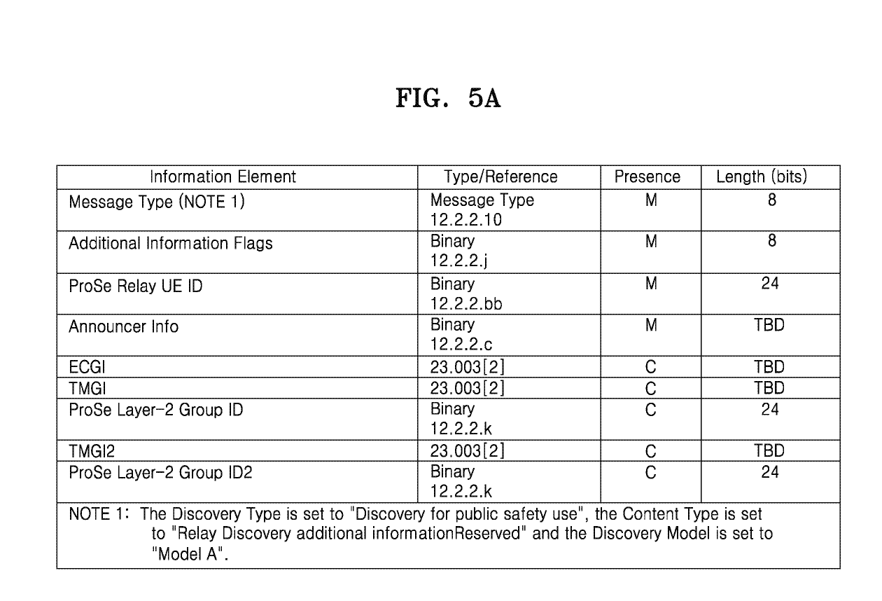

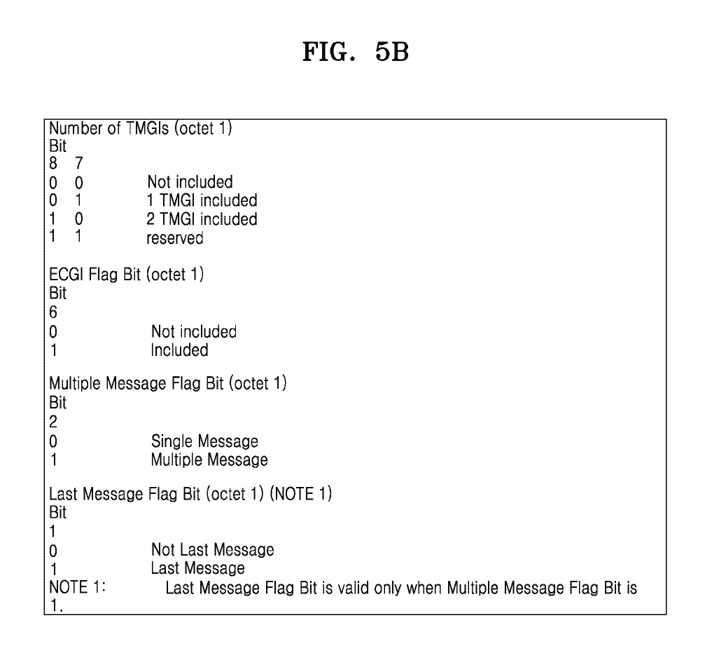

FIG. 5A shows a table for explaining parameters constituting a relay discovery message according to another embodiment.

As illustrated in FIG. 5A, the relay discovery message may include parameters related to the message type, the supplementary information flag, the ProSe relay UE ID, the announcer information, ECGI, TMGI1, ProSe layer 2 group ID1, TMGI2, and ProSe layer 2 group ID2, and information on parameters. It will be understood by those skilled in the art that the relay discovery message may further include parameters other than the parameters illustrated in FIG. 5A.

FIG. 5B shows a table for explaining the parameters disclosed in FIG. 5A.

Referring to FIG. 5B, when the bit of the ECGI flag is about 0, the ECGI may not be included in the relay discovery message. When the bit of the ECGI flag is about 1, the ECGI may be included in the relay discovery message and a value of ECGI may be obtained therefrom.

When a value of TMGI is about 0, TMGI1, ProSe layer 2 group ID1, TMGI2, ProSe layer 2 group ID2 may not be included in the relay discovery message. When the value of TMGI is about 1, TMGI1 and ProSe layer 2 group ID1 may be valid, but TMGI2 and ProSe layer 2 group ID2 may be invalid. Thus, values of the parameters of TMGI1 and ProSe layer 2 group ID1 may be obtained from the relay discovery message.

On the other hand, when the value of TMGI is about 2, TMGI1 and ProSe layer 2 group ID1 may be invalid, but TMGI2 and ProSe layer 2 group ID2 may be valid. Thus, values of the parameters of TMGI2 and ProSe layer 2 group ID2 may be obtained from the relay discovery message.

In addition, when the size of the relay discovery message is larger than the permitted size of the message, the multiple message flag may be set to about 1 and information on the message may be transmitted via the multiple message. When the multiple message flag is about 0, the message may be a single message and the last message flag may be invalid. On the other hand, when the multiple message flag is about 1, the message may be at least one message and the last message flag may be valid. In addition, when the last message flag is about 0, the message may not be the last message. When the last message flag is about 1, the message may be the last message.

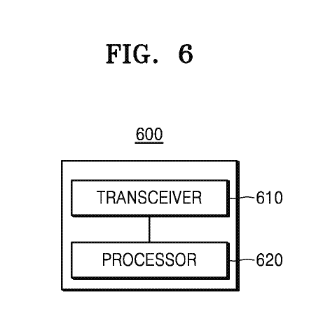

FIG. 6 is a block diagram illustrating a terminal 600 used in the ProSe communication according to an embodiment.

The terminal 600 may include a transceiver 610 and a processor 620. In addition, it will be understood by those skilled in the art that other general-purpose components other than the components illustrated in FIG. 1 may be further included.

The transceiver 610 may be connected to the processor 620, and may transmit and/or receive wireless signals.

The processor 620 may determine whether the size of the relay discovery message that the terminal 600 is to transmit exceeds a permitted size. When the size of the relay discovery message exceeds the permitted size, the processor 620 may broadcast a plurality of relay discovery messages, based on information on the relay discovery message and the group related to the terminal 600.

The processor 620 may determine whether the terminal 600 is to transmit information on a plurality of groups related to the terminal 600. The processor 620 may broadcast a plurality of relay discovery messages including information indicating whether to transmit information on the plurality of groups.

When the terminal 600 transmits information on the plurality of groups (for example, the first group and the second group), the processor 620 may broadcast a first relay discovery message including information on the first group among the plurality of groups. Here, the first relay discovery message may include a first link layer identifier of the first group used for the group communication or the link layer identifier corresponding to a group of UEs belonging to the first group. The processor 620 may broadcast a second relay discovery message including information on the second group among the plurality of groups. Here, the second relay discovery message may include a second link layer identifier of the second group used for the group communication or the link layer identifier corresponding to a group of UEs belonging to the second group.

In addition, the processor 620 may include information indicating whether each of the plurality of relay discovery messages is the last message in each of the plurality of relay discovery messages, and broadcast the result thereof.

In addition, the relay discovery message may include at least one of the SIP URI, the application information, the IP address, and the port number related to the terminal 600. When the size of the relay discovery message exceeds the permitted size, the processor 620 may hash or compress information related to at least one of the SIP URI, the application information, the IP address, and the port number.

The UE may further include a memory (not illustrated). The memory (not illustrated) may be connected to the processor 620 to store protocols or parameters for operations.

The processor 620 may include an application-specific integrated circuit (ASIC), other chipset, logic circuitry and/or a data processing device. The memory (not illustrated) may include read-only memory (ROM), random access memory (RAM), flash memory, memory card, storage media, and/or other storage device. The transceiver 610 may include a baseband circuit for processing radio signals. When the embodiment is implemented in software, the above-described technique may be implemented as a module (process, function, etc.) which performs the above-described function. The module may be stored in the memory and may be executed by the processor 620. The memory may be inside or outside the processor 620 and may be connected to the processor 620 in various well known methods.

In the above-described example wireless communication system, although the methods are described on a basis of flowcharts as a series of steps or blocks, the present invention is not limited to the order of steps, and some steps may be performed in a different order than the steps described above or at the same time. In addition, it will be understood by one of ordinary skill in the art that the steps shown in the flowchart are not exclusive and that other steps may be included or that one or more steps in the flowchart may be deleted without affecting the scope of the invention.

The above-described embodiments may include examples of various aspects. While it is not possible to describe every possible combination for expressing various aspects, one of ordinary skill in the art will recognize that other combinations are possible. Accordingly, it is intended that the present invention includes all alternatives, modifications and variations that fall within the scope of the following claims.

All references, including publications, patent applications, and patents, cited in the disclosed embodiments are hereby incorporated by reference to the same extent as if each reference were individually and specifically indicated to be incorporated by reference and were set forth in its entirety herein.

For the purposes of promoting understanding of the principles of the disclosed embodiments, reference has been made to the exemplary embodiments illustrated in the drawings, and specific language has been used to describe these embodiments. However, no limitation of the scope of the inventive concept is intended by this specific language, and the inventive concept should be construed to encompass all embodiments that would normally occur to one of ordinary skill in the art.

The disclosed embodiments may be described in terms of functional block components and various processing steps. Such functional blocks may be realized by any number of hardware and/or software components configured to perform the specified functions. For example, the present invention may employ various integrated circuit (IC) components such as memory elements, processing elements, logic elements and look-up tables, which may carry out a variety of functions under the control of one or more microprocessors or other control devices. Similarly, where the elements of the present invention are implemented using software programs or software elements, the present invention may be implemented with any programming or scripting language such as C, C++, Java, assembler language, etc., with the various algorithms being implemented with any combination of data structures, objects, processes, routines or other programming elements. Functional aspects may be implemented in algorithms that are executed on one or more processors. In addition, the present invention may employ any number of conventional techniques for electronics configuration, signal processing and/or control, data processing, etc. The terms “mechanism,” “element,” “means,” and “configuration” may be broadly used and may not be limited to mechanical or physical embodiments. The terms may include software routines in conjunction with processors, etc.

The particular implementations shown and described herein may be illustrative examples of the present invention and may not be intended to otherwise limit the scope of the present invention in any way. For the sake of brevity, conventional electronics, control systems, software development and other functional aspects of the systems may not be described in detail. Furthermore, the connecting lines, or connectors shown in the various figures presented may be intended to represent exemplary functional relationships and/or physical or logical couplings between the various elements. It should be noted that many alternative or additional functional relationships, physical connections or logical connections may be present in a practical device. Moreover, no item or component is essential to the practice of the present invention unless the element is specifically described as “essential” or “critical”.

Although the embodiments have been described above by limited embodiments and figures, it will be understood by one of ordinary skill in the art that various modifications and equivalent arrangements from the described-above descriptions. For example, it should be understood that the techniques described may be performed in a different order than the described methods, and/or that components of the described systems, structures, devices, circuits, etc. are connected or combined, or are replaced or substituted by other equivalent components or other equivalents.

Therefore, the scope of the present invention should not be limited to the described embodiments, but should be determined by the equivalents of the claims, as well as the claims.

1. A method of operating first user equipment (UE) in a wireless communication system, the method comprising:
determining whether a size of a relay discovery message to be transmitted by the first UE exceeds a permitted size; and
broadcasting a plurality of relay discovery messages, based on the relay discovery message and information on a group related to the first UE, when it is determined that the size of the relay discovery message exceeds the permitted size.

2. The method of claim 1, wherein the broadcasting of the plurality of relay discovery messages comprises:
determining whether the first UE transmits information about a plurality of groups related to the first UE; and
broadcasting a plurality of relay discovery messages including information indicating whether the first UE transmits the information about the plurality of groups.

3. The method of claim 2, wherein, when the first UE transmits information about the plurality of groups, the broadcasting of the plurality of relay discovery messages comprises:
broadcasting a first relay discovery message including information about a first group among the plurality of groups; and
broadcasting a second relay discovery message including information about a second group among the plurality of groups.

4. The method of claim 2, wherein, in the broadcasting of the plurality of relay discovery messages, each of the plurality of relay discovery messages comprises information indicating whether the corresponding relay discovery message is a last message.

5. The method of claim 1, further comprising establishing a connection for direct communication with a second UE which has been determined as a UE-to-network relay.

6. The method of claim 3, wherein the first relay discovery message comprises a first link layer identifier of the first group used for group communication or a link layer identifier corresponding to a UE group belonging to the first group, and the second relay discovery message comprises a second link layer identifier of the second group used for the group communication or a link layer identifier corresponding to a UE group belonging to the second group.

7. The method of claim 1, wherein the relay discovery message is one of a UE-to-network relay discovery announcement message, a UE-to-network relay discovery solicitation message, a UE-to-network relay discovery response message, a group member discovery announcement message, a group member discovery solicitation message, a group member discovery response message, a relay discovery additional information message, a temporary mobile group identify (TMGI) monitoring request message, and a TMGI monitoring response message.

8. The method of claim 1, wherein the relay discovery message comprises at least one of a session initiation protocol uniform resource identifier (SIP URI), application information, an internet protocol (IP) address, and a port number, which are related with the first UE, and
when it is determined that the size of the relay discovery message exceeds the permitted size, the method further comprises hashing or compressing information related to the at least one of the SIP URI, the application information, the IP address, and the port number.

9. A terminal operating in a wireless communication system, the terminal comprising:
a transceiver; and
a processor,
wherein the processor is configured to determine whether a size of a relay discovery message to be transmitted by the terminal exceeds a permitted size, and when it is determined that the relay discovery message exceeds the permitted size, broadcast a plurality of relay discovery messages, based on information about a group related to the relay discovery message and the terminal.

10. The terminal of claim 9, wherein the processor is further configured to determine whether the terminal will transmit information about a plurality of groups related to the terminal, and broadcast a plurality of relay discovery messages comprising information indicating whether the terminal has transmitted the information about the plurality of groups.

11. The terminal of claim 10, wherein, when the terminal transmits the information on the plurality of groups, the processor is further configured to broadcast a first relay discovery message comprising information about a first group among the plurality of groups, and broadcast a second relay discovery message comprising information about a second group among the plurality of groups.

12. The terminal of claim 9, wherein the processor broadcasts the plurality of relay discovery messages, each of which comprises information about whether a corresponding relay discovery message is a last message.

13. The terminal of claim 11, wherein the first relay discovery message comprises a first link layer identifier of the first group used for the group communication or a link layer identifier corresponding to a UE group belonging to the first group, and the second relay discovery message comprises a second link layer identifier of the second group used for the group communication or a link layer identifier corresponding to a UE group belonging to the second group.

14. The terminal of claim 9, wherein the relay discovery message comprises at least one of an SIP URI, application information, an IP address, and a port number, which are related to the terminal, and
when it is determined that the size of the relay discovery message exceeds the permitted size, the processor is further configured to hash or compress information related to the at least one of the SIP URI, the application information, the IP address, and the port number
